(19) United States
(12) Patent Application Publication
(10) Pub. No.: US 2008/0262669 A1
(43) Pub. Date: Oct. 23, 2008

(54) AUTONOMOUS VEHICLE CONTROLLER

(75) Inventors: Edzko Smid, Troy, MI (US); Paul Fleck, Troy, MI (US); Ka C. Cheok, Troy, MI (US); Tom Stiglich, Troy, MI (US)

Correspondence Address: DOBRUSIN & THENNISCH PC, 29 W LAWRENCE ST, SUITE 210, PONTIAC, MI, 48342, US

(73) Assignee: Jadi, Inc.

(21) Appl. No.: 11/857,700

(22) Filed: Sep. 19, 2007

Related U.S. Application Data
(60) Provisional application No. 60/826,641, filed on Sep. 22, 2006.

(51) Int. Cl. G05D 1/00

(52) U.S. Cl. 701/23

(57) ABSTRACT

The present invention relates to a controller for providing a vehicle with autonomous control. The controller preferably provides path planning to an autonomous vehicle.

### CLAIM OF PRIORITY

This application claims the benefit of the filing date of U.S. Provisional Application No. 60/826,641 filed Sep. 22, 2006.

### FIELD OF THE INVENTION

The present invention relates to a controller for providing a vehicle with autonomous control and, preferably, with a method of providing path planning to an autonomous vehicle.

### BACKGROUND OF THE INVENTION

It has become increasingly desirable to have vehicles that are able to operate (e.g. move and/or carry out assigned tasks) without direct control from a human operator. Such autonomous vehicles (AVs) have the ability to operate without direct control of a human and allow human operators to remove themselves to a safe distance to avoid potentially dangerous situations. AVs also permit the human operators to delegate repetitive tasks to the vehicle.

Retrofitting vehicles to achieve autonomous control has been prohibitively expensive because each vehicle has a different set of hardware and software requirements. Thus, many vehicles that could benefit from autonomous control (e.g., forklifts, tractors, golf ball collection vehicles, farm or lawn mower equipment, mobile camera security vehicles, warehouse vehicles or the like) could not be retrofitted, but rather had to be replaced with vehicles where the autonomous control is part of the original equipment manufacturing.

Several draw backs exist with autonomous vehicles known to date. They are too specialized in their control systems, meaning that the control system is not easily replicated for other vehicles. Moreover, the specialized control systems mean that there is little if any interoperability between vehicles from different manufactures and different standards. Thus, it is desirable to have a broadly applicable method of providing autonomous control that permits interoperability.

Another draw back is path planning for the autonomous vehicle. Previous methodologies of path planning involve creating a set of waypoints for the autonomous vehicle to follow from a starting point to an ending point. The waypoints have to be manually created and input into the AV. This is time consuming and works well only for situations where the area of movement is limited and remains the same, such a small warehouse or a small perimeter fence. Another form of path planning involves allowing the vehicle to pick its own path as the vehicle moves. However, systems require large numbers of environmental sensors and large amounts of computing power to synthesize all the data generated by the sensors.

Another problem with prior art systems is that such systems often require a large amount of infrastructure (e.g., buried cable, reflector systems or the like) for their operation and either new vehicles must be built to work with the infrastructure or large sums of capital must be spent to retrofit current vehicles to operate within the infrastructure.

The present invention overcomes one or more of these problems.

### SUMMARY OF THE INVENTION

Thus, the present invention provides an autonomous vehicle controller for providing autonomous control to a vehicle. The controller includes a vehicle interface that communicates with the vehicle and provides instructions to the vehicle regarding acceleration, braking, steering or a combination thereof. The controller includes an operator interface that communicates with and receives instructions from an operator, the instructions including task instructions, path planning information or both. The controller includes an environmental sensor array that receives sensor data from the vehicle and communicates the sensor data to the vehicle interface such data including vehicle speed, compass heading, absolute position, relative position or a combination thereof. The sensor array prefereably includes an UWB sensor. Further, the autonomous vehicle controller includes a processing unit having software for communicating with the vehicle interface, the operator interface, the environmental sensor array or a combination thereof and further including a central processing unit, memory, storage, communication ports, antennae or a combination thereof. In the preferred embodiment, the vehicle interface, the operator interface, the environmental sensor array and the processing unit are combined as a singular integrated unit. Typically the controller provides autonomous control to the vehicle for a period of time.

### BRIEF DESCRIPTION OF THE DRAWINGS

FIG. 1 is a schematic diagram of an exemplary autonomous vehicle controller in a working environment according to an aspect of the present invention.

FIG. 2 is a schematic diagram of an exemplary autonomous vehicle controller according to an aspect of the present invention.

FIG. 3 is a schematic diagram of an exemplary operation of the autonomous vehicle controller according to an aspect of the present invention.

### DETAILED DESCRIPTION

The present invention includes an autonomous vehicle controller (AVC).

The AVC may be used to provide autonomous control to many different types of vehicles. Autonomous control means that after initialization, the vehicle moves and/or accomplishes one or more tasks without further guidance from a human operator, even if the human operator is located on or within the vehicle. The period of autonomous control may range from a less than a minute to an hour to several hours to several days or weeks at a time.

Suitable vehicles also include transportation vehicles such as automobiles, boats, submarines, airplanes, helicopters, or the like whose primary purpose is to transport passengers. Suitable non-transportation vehicles include those whose primary purpose is to accomplish a task other than transporting passengers such as moving inventory, cargo, construction materials, or natural materials (e.g. ore) or providing information about an environment such as scanning for the presence of humans, animals or other vehicles or scanning geological features (e.g. sea floor scanning or using ground penetrating radar). Suitable non-transportation vehicles include trucks, construction vehicles, warehouse vehicles, cargo hauling vehicle, unmanned motorized vehicles such as sentry robots, aerial drones and the like. Other suitable non-transportation vehicles include those used for exploration, scouting, reconnaissance, and/or mapping. Furthermore, all vehicles that are drive-by-wire (or include at least one drive-by-wire feature) or tele-operated are suitable for use with the AVC. Moreover, non-drive-by-wire vehicle and other types of vehicles can include a mechanical to electrical interface to more readily adapt those vehicles to operate with the AVC.

The controller comprises a vehicle interface, an operator interface, an environmental sensor array, and a processing unit.

The vehicle interface is the portion of the AVC that communicates with the vehicle. The communication between the AVC and the vehicle may be carried on any suitable data bus with CAN (e.g. ISO 11898-1) and/or PWM buses preferred. The vehicle interface is also preferably matched to the vehicle to ease retrofitting of the vehicle. For example, for tele-operated and drive-by-wire capable vehicles, the vehicle interface will use these systems to communicate with the vehicle. While typically a wireline communication technique will be utilized, wireless communication techniques are also contemplated.

Communications between the AVC and the vehicle include instructions from the AVC. Instructions may include instructions (e.g., commands) on moving the vehicle such as providing acceleration, braking and/or steering to the vehicle. Instructions may also include instruction on carrying out tasks by the vehicle such as raising and lowering the forks of forklift or initiating scanning by a sentry robot. Communication between the AVC and the vehicle include sensor data from the environmental sensor array. Sensor data includes any information that the sensor array generates during the operation of the array. For example, sensor data may include vehicle speed, compass heading, absolute position (e.g. from GPS), relative position (e.g. relative to one or more other vehicles or buildings) or the like as discussed below. The vehicle interface is the means for AVC to receive information from the sensor array and for issuing instructions to control the vehicle. The instructions provided by the AVC to the vehicle are typically commands and those commands are typically simple movements (e.g., forward, up, down, etc.), although more complex instructions may also be provided.

The AVC also includes an operator interface. The operator interface is the portion of the AVC that communicates with the operator (e.g., a human being or central computer system). For all autonomous vehicles, at some point, a human operator is required to at least initiate or re-initiate the vehicle. To do this, the operator interface receives instructions (e.g., voice instruction or hand signals) from the operator (e.g. path planning information or task instructions) via a suitable input device. Both wireless and wireline devices are suitable and may be mounted on the vehicle itself or located remotely from the vehicle. A general purpose computer with a mouse or joystick that communicates wirelessly with the vehicle via the operator interface is one example. Wireless control through the use of stylus on a PDA, smart phone or tablet computer is another example. Voice instructions (e.g., commands) may also be used by the operator to communicate with the vehicle. For vehicles that may operate both with human operators and autonomously, a joystick, steering wheel, acceleration pedal, brake or the like may be used to communicate via the vehicle interface. While desirable, but not necessary, the operator interface may also communicate information from the vehicle to the operator such as giving vehicle speed, position information or vehicle status information (e.g. a fault has occurred). In another embodiment, the AVC communicates with a central computer that is responsible for the control of a plurality of vehicles all using an AVC.

The AVC also includes an environmental sensor array. The sensor array includes any suitable device that monitors the vehicle or the local environmental of the vehicle. For example, the sensors may monitor the operating status of the vehicle such engine operating conditions, fuel level, battery level, engine temperature, hydraulic fluid levels, electric systems, and status of other sensors in the sensor array. Further, the sensors monitor the local environment of the vehicle. For example, the sensors may monitor the vehicle's absolute position such as through GPS or similar system. The relative position may be monitored using a localized grid having base stations (see e.g. U.S. Patent Publication 20050215269, which is incorporated by reference). Collision avoidance sensors may be used in the sensor array such as a bumper switch, short range sonar (e.g. ultrasonic), short range radar systems (e.g. infrared) or camera based systems (e.g. lane departure warning systems). Sensors that monitor visibility conditions (e.g. darkness, fog, or the like), weather conditions (e.g. temperature, humidity, wind speed, precipitation, or the like), air quality, solar power, or the like may be included as well as sensors that monitor for specific types of contaminants or pathogens.

Other suitable sensors in the array monitor the motion (absolute or relative) of the vehicle such as the rate of acceleration, the pitch rate, the roll rate and the yaw rate. Exemplary motion sensors include accelerometers, gyroscopes, speedometers, or the like. For example, an accelerometer may be used to measure the acceleration of the platform relative to an external mass (e.g. the Earth or a building), whereas a gyroscope may be used to measure the rate of the pitch, roll, yaw or all three of the vehicle relative to the external mass (e.g. the moon).

Other suitable sensors include position sensors which may be used to determine the location of any task performing component of the vehicle (e.g. the forks of a forklift or the bucket of a crane) including those that determine the orientation or position of the component relative to the vehicle. Suitable position sensors include joint angle sensors, one or more encoders, potentiometers, resolvers, linear variable differential transducers (LVDT) or actuators that may operate as position sensors. Also, task specific sensors can be included. Such sensors can sense environmental conditions that exist for one, two, three or more specific tasks.

Another class of sensors includes antennae for sending and receiving information wirelessly, and includes RF, UWB and antennae for communications such as discussed elsewhere in this application. RFID tags may also be used to send and receive information or otherwise identify the vehicle. Moreover, RFID tags may also be used to receive positioning information or receive instructions and/or task performing information.

Preferably, the sensors are solid state devices based on MEMS technology as these are very small, are light weight and have the necessary accuracy while not being cost prohibitive. Each utilized sensor provides a suitable output signal containing the information measured by the sensor. The sensor output signal may be in any data format useable by the processing unit, but preferably will be digital. Furthermore, wireline or wireless communication links may be utilized to transfer signals between the sensor array and the processing unit.

It shall be understood that, in each instance where the AVC is discussed as including a sensor, the AVC may actually include a sensor input that receives data from a sensor external to the AVC. For example, the AVC can include a speedometer or it can include a speedometer input that receives data from the speedometer of a vehicle to which the AVC has been applied. Thus, as used herein, a sensor is intended to include the sensor itself, an input for that sensor or both.

The AVC also includes a processing unit that comprises a central processing unit, memory, storage, communication ports, antennae and any software necessary to communicate with the vehicle interface, the operator interface and/or the environmental sensor array. In one embodiment, the processing unit includes removable storage so that stored data may be retrieved even in the absence of wireline or wireless communications network.

In one embodiment, the software includes software for path planning as discussed below. The software may also include techniques suitable for providing the AVC with the ability to learn from its past mistakes. Preferably the software will include adaptive systems that allow the AVC to self-tune based on external parameters and conditions as gathered by the sensors of the sensor array. Preferably, the adaptive systems include the ability to self-tune in real time.

It is contemplated that the AVC includes an intelligent design such that the AVC includes programming of rules and programming for changing those rules. Programming of rules will typically include programming for following instructions provided by a user according to a protocol. Then, upon sensing of an external change of conditions, the AVC will typically include programming to change the protocol. Then, such changed protocol can be stored and used in the future such that the original rules or protocol has been changed. As an example, original rules may map a path of waypoints to be directly followed by vehicle having the AVC and, upon sensing of an obstacle in the direct path between way points, the original rule of following a direct path can be modified to allow the vehicle to follow a path around the obstacle. In another example, a rule can be used to change a parameter value of a drive control rule to adapt to terrain variations.

In addition, it is contemplated that the one AVC may be able to transfer data to another AVC. Thus instructions (e.g., rules) and instruction changes (e.g., rule changes) can be transferred from one AVC to another such that one AVC can be replaced with a second AVC on one vehicle or data from one AVC on a first vehicle can be transferred to an AVC on a second vehicle such that the second AVC can perform the task that were originally being performed by the first vehicle.

The components of the AVC are preferably housed in a single integrated unit that facilitates the placement of the AVC in or on a vehicle that is to be retrofitted with the AVC. Such a singular integrated unit will typically include the vehicle interface, the operator interface, the environmental sensor array, the processing unit or any combination thereof. Such components will typically be within the housing of the unit, attached (e.g., directly attached) to the housing or both.

For all communication that takes place within the AVC or between the AVC and outside components, any suitable protocol may be used such as CAN, USB, Firewire, JAUS (Joint Architecture for Unmanned Systems), TCP/IP, or the like. For all wireless communications, any suitable protocol may be used such as standards or proposed standards in the IEEE 802.11 or 802.15 families, related to Bluetooth, WiMax, Ultrawide Band or the like. For communication that takes place between the AVC and a central computer, protocols like Microsoft Robotics Studio or JAUS may be used. For long range communication between the AVC and the operator, existing infrastructure like internet or cellular networks may be used. For that purpose, the AVE may used the IEEE 802.11 interface to connect to the internet or may be equipped with a cellular modem.

The present invention also comprises a method of path planning for an AV. Path planning is providing a plurality of waypoints for the AV to follow as it moves. With the current method, path planning can be done remotely from the AV, where remotely means that the human operator is not physically touching the vehicle and may be meters or kilometers away from the vehicle. Locating the human operator 10 s, 100 s or 1000 s of kilometers from the vehicle protects the operator from dangerous situations while also allowing centralized control of many vehicles.

The method of path planning comprises marking a path of waypoints on a digitized geospatial representation and utilizing coordinates of the way points of the marked path. Marking a path comprises drawing a line from a first point to a second point. For example, a stylus or mouse may be used to draw a line on a digitized geospatial representation hosted on a desktop, laptop or palmtop PC or a PDA. In one embodiment, the software to carry out the path planning is optionally implemented with Microsoft Robotics Studio as it is highly flexible and extendible and easily ported to operate different AVs.

Path marking results in two possible outcomes: 1) the marked path does not enclose an area; or 2) the marked path encloses an area (called a scan area). In the first situation, the path is a line of waypoints that will allow the vehicle to travel some distance.

In the second situation, in addition to creating a series of waypoints for the perimeter of the scan area, a path may be marked for coverage of the interior or scan area by the AV. For example, with an autonomous minesweeper, marking a path may include drawing on the representation around a suspected mine field. Next, marking a path of waypoints that will allow the mine sweeper to investigate the entire scan area may be done. Generally, the path through the scan area will be a series of parallel scan lines that fill the scan area. The distance between the scan lines and the angle (e.g. from true north) of the scan lines may be adjusted to conform to the needs of the situation, such as ranges of sensors in the environmental sensor array of the AV or the terrain of the scan area. Overlapping series of scan lines may also be used to form a grid within the scan area. Other situations where scan areas may find use are in landscaping (e.g. mowing grass on a golf course), farming, search and rescue (e.g. on land or over sea), sea floor investigation, among other applications.

A digitized geospatial representation is any picture or map that has absolute or relative position coordinates associated with individual portions (e.g. a pixel or a group of pixels) of the picture or map. The path marked on the representation corresponds to a series of coordinates (e.g. longitude, latitude and/or altitude) that are stored as way points for later use by the AVC in operating the vehicle.

Any of several commercially available digitized geospatial representations that provide absolute position (e.g. GPS coordinates) may be used in this method and include Google Earth and Microsoft Virtual Earth. Other representations with absolute position information may also be used such as those that are proprietary or provided by the military.

Moreover, digitized geospatial representations with relative position information may also be used such as ad hoc grids like those described in U.S. Patent Publication 20050215269. The ad hoc grids may be mobile, stationary, temporary, permanent or combinations thereof, and find special use within building and under dense vegetative ground cover where GPS may be inaccessible. Other relative position information may be used such as the use of cellular networks to determine relative position of cell signals to one another.

Combinations of absolute and relative position information may be used, especially in situations where the vehicle travels in and out of buildings or dense vegetation.

In addition, to marking a path on the geospatial representation, information about a vehicle, sensor or other objects may be displayed on the representation as a method of assisting the human operator in path planning for a vehicle. For example, an activated alarm may be displayed on the representation so that the human operator may deploy a sentry robot to investigate the alarm by marking a path on the representation.

The coordinates of the waypoints of the marked path are then utilized, whether that means storing the data for later use, caching the data in preparation for near term use or immediately using the data by communicating the data to an outside controller (e.g. an AVC). For example, the data may be communicated to the processing unit of the AVC, such as through the operator interface. The processing unit may then issue instructions through the vehicle interface to operate the AV, or otherwise store the data in the processing unit.

Moreover, other types of path planning may also be utilized with the AVC. For example, recording the movement of the vehicle when operated by a human could be used to generate waypoints. Other types of manual path planning may also be used. In addition, path planning may be accomplished through the use of image recognition techniques. For example, planning a path based on a camera mounted to the vehicle to avoid objects. In another embodiment, path planning may be accomplished identifying portions of a digitized geospatial representation that is likely to indicate a road or street suitable for the vehicle to travel on.

With any type of path planning, the generated waypoint data may be manipulated through hardware or software to smooth the data, remove outliers or otherwise clean up or compress the data to ease the utilization of the data.

Moreover, the marked path may include boundary conditions (e.g. increasingly hard boundaries) on either side of the path to permit the vehicle to select a path that avoids objects that may be found on the original marked path.

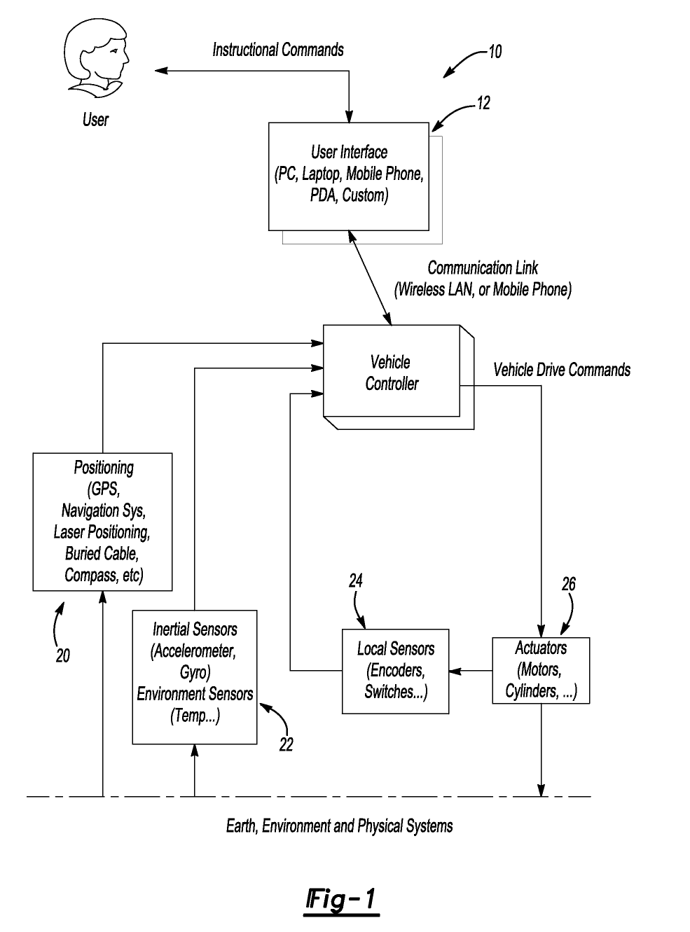

As one example, a system 10 according to the present invention is illustrated in FIG. 1. The system 10 includes a user interface 12 for communication with the AVC 14. As, shown, the AVC 14 includes multiple sensors 20, 22, 24, 26 (i.e., the actual sensors or sensor inputs) for gathering data.

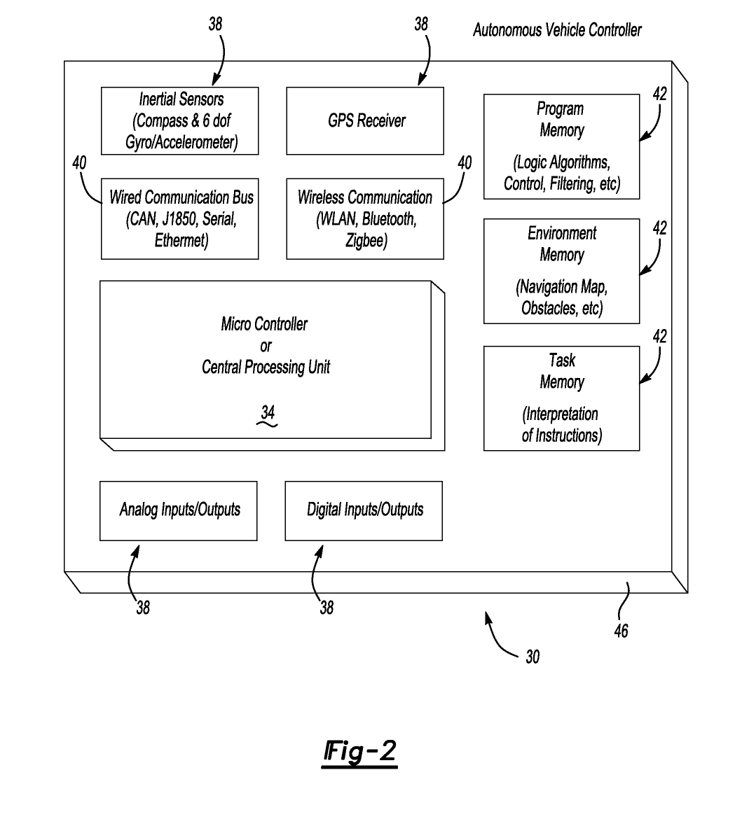

FIG. 2 illustrates a potential AVC 30 suitable for use as the AVC 14 if FIG. 1 or otherwise. As shown the AVC 30 includes a micro controller or central processing unit 34, sensors 38 (e.g., sensors or sensor inputs) of a sensor array, wireless and/or wired communication mechanisms 40 and memory 42. In the embodiment illustrated, each of the components 34, 38, 40, 42 is part of an integral singular unit (e.g., housed within or attached to a housing 46) that can be installed within a new vehicle, can be retrofit to an already existing vehicle or can be moved from vehicle to vehicle.

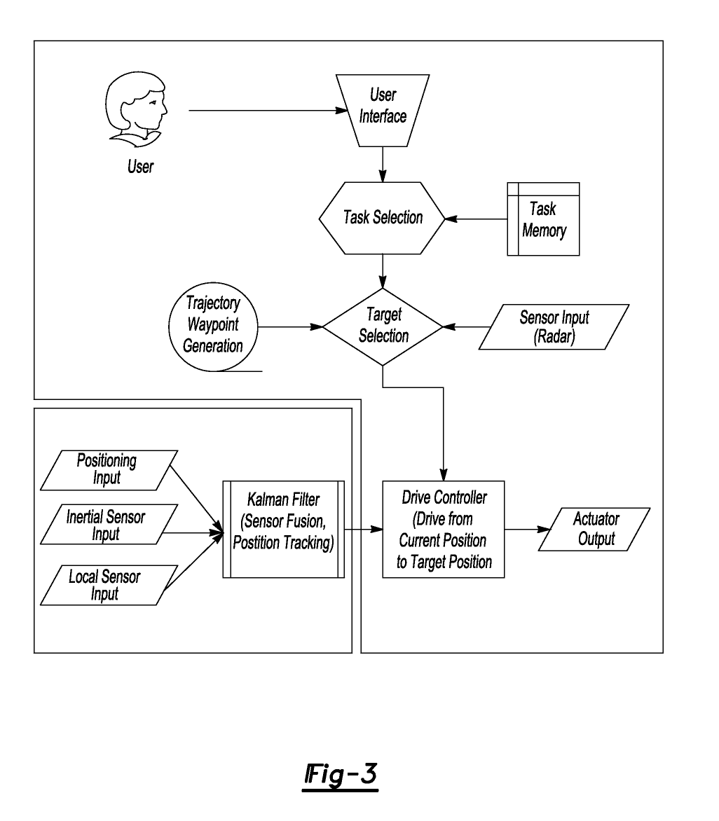

FIG. 3 illustrates the operation of the AVC with a vehicle and a user interface. The particular operation being illustrated is movement of a vehicle from one location to another by used of waypoints.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. An autonomous vehicle controller for providing autonomous control to a vehicle, comprising:
a vehicle interface that communicates with the vehicle and provides instructions to the vehicle regarding acceleration, braking, steering or a combination thereof;
an operator interface that communicates with and receives instructions from an operator, the instructions including task instructions, path planning information or both;
an environmental sensor array that receives sensor data from the vehicle and communicates the sensor data to the to the vehicle interface such data including vehicle speed, compass heading, absolute position, relative position or a combination thereof; and
a processing unit having software for communicating with the vehicle interface, the operator interface, the environmental sensor array or a combination thereof;
wherein the controller provides autonomous control to the vehicle for a period of time.

2. A controller as in claim 1 wherein the period of time of autonomous control is at least one hour after instructions are provided to the operator interface.

3. A controller as in claim 1 wherein the vehicle interface communicates with the vehicle via a wireless communication system and wherein the operator interface communicates information from the vehicle to the operator, such information including vehicle speed, position information, fault information or a combination thereof.

4. A controller as in claim 1 wherein the sensor array monitors engine operating conditions, fuel level, battery level, engine temperature, hydraulic fluid levels, electric systems or a combination thereof of the vehicle.

5. A controller as in claim 1 wherein the sensor array monitors status of other sensors in the sensor array.

6. A controller as in claim 1 wherein the sensor array includes collision avoidance sensors, which include a bumper switch, short range sonar, short range radar, a camera based system or a combination thereof.

7. A controller as in claim 1 wherein the sensor array includes sensors that monitor visibility conditions, weather conditions, air quality, solar power or a combination thereof.

8. A controller as in claim 1 wherein the sensor array includes at least one sensor that monitors motion of the vehicle including rate of acceleration, pitch rate, roll rate, yaw rate or a combination thereof and the at least one sensor that monitors motion includes an accelerometer, a gyroscope, a speedometer or a combination thereof.

9. A controller as in claim 1 wherein the sensor array includes an UWB sensor.

10. A controller as in claim 1 wherein the vehicle interface, the operator interface, the environmental sensor array and the processing unit are within or attached to a housing.

11. A controller as in claim 1 wherein the AVC is programmed to provide path planning to the AV and such path planning includes marking a path of waypoints on a digitized geospatial representation.

12. An autonomous vehicle controller for providing autonomous control to a vehicle, comprising:
a vehicle interface that communicates with the vehicle and provides instructions to the vehicle regarding acceleration, braking, steering or a combination thereof;
an operator interface that communicates with and receives instructions from an operator, the instructions including task instructions, path planning information or both;
an environmental sensor array that receives sensor data from the vehicle and communicates the sensor data to the to the vehicle interface such data including vehicle speed, compass heading, absolute position, relative position or a combination thereof Wherein the sensor array includes an UWB sensor; and
a processing unit having software for communicating with the vehicle interface, the operator interface, the environmental sensor array or a combination thereof and further including a central processing unit, memory, storage, communication ports, antennae or a combination thereof;
wherein the vehicle interface, the environmental sensor array and the processing unit are combined as a singular integrated unit; and
wherein the controller provides autonomous control to the vehicle for a period of time.

13. A controller as in claim 12 wherein the period of time of autonomous control is at least one hour after instructions are provided to the operator interface.

14. A controller as in claim 12 wherein the vehicle interface, the operator interface, the environmental sensor array and the processing unit are within or attached to a housing.

15. A controller as in claim 12 wherein the processing unit includes the storage and the storage includes a removable data storage so that stored data can be retrieved in the absence of wireline or wireless communications network and wherein the sensor array includes a sensor that is a solid state device based on MEMS technology.

16. A controller as in claim 12 wherein the AVC is programmed to provide path planning to the AV and such path planning includes marking a path of waypoints on a digitized geospatial representation.

17. A controller as in claim 16 wherein the waypoints mark a path that is the perimeter of a scan area that the AV then scans.

18. A controller as in claim 17 wherein the AV scans the scan area by traveling to waypoints within the scan area.

19. A controller as in claim 18 wherein the AVC employs a digitized geospatial representation that provides absolute position of the AV in creating the scan area or provides relative position through the use of an ad hoc grid.

20. An autonomous vehicle controller for providing autonomous control to a vehicle, comprising:
a vehicle interface that communicates with the vehicle and provides instructions to the vehicle regarding acceleration, braking, steering or a combination thereof;
an operator interface that communicates with and receives instructions from an operator, the instructions including task instructions, path planning information or both;
an environmental sensor array that receives sensor data from the vehicle and communicates the sensor data to the to the vehicle interface such data including vehicle speed, compass heading, absolute position, relative position or a combination thereof wherein the sensor array includes an UWB sensor; and
a processing unit having software for communicating with the vehicle interface, the operator interface, the environmental sensor array or a combination thereof and further including a central processing unit, memory, storage, communication ports, antennae or a combination thereof;
wherein the vehicle interface, the operator interface, the environmental sensor array and the processing unit are combined as a singular integrated unit;
wherein the autonomous control continues for a period of time of at least one hour after instructions are provided to the operator interface;
wherein the sensor array monitors engine operating conditions, fuel level, battery level, engine temperature, hydraulic fluid levels, electric systems or a combination thereof of the vehicle;
wherein the sensor array monitors status of other sensors in the sensor array;
wherein the sensor array includes collision avoidance sensors, which include a bumper switch, short range sonar, short range radar, a camera based system or a combination thereof;
wherein the sensor array includes at least one sensor that monitors motion of the vehicle including rate of acceleration, pitch rate, roll rate, yaw rate or a combination thereof and the at least one sensor that monitors motion includes an accelerometer, a gyroscope, a speedometer or a combination thereof;
wherein the AVC is programmed to provide path planning to the AV and such path planning includes marking a path of waypoints on a digitized geospatial representation;
wherein the waypoints mark a path that is the perimeter of a scan area that the AV then scans;
wherein the AV scans the scan area by traveling to waypoints within the scan area; and
wherein the AVC employs a digitized geospatial representation that provides absolute position of the AV in creating the scan area or provides relative position through the use of an ad hoc grid; and
wherein the AVC includes a mechanism for receiving communication from a cellular phone or the internet such that a user can communicate with the AVC through the mechanism.
